(19) United States
(12) Patent Application Publication
(10) Pub. No.: US 2007/0008081 A1
(43) Pub. Date: Jan. 11, 2007

(54) MP3 doorbell chime system

(76) Inventors: Scott Blaise Tylicki, Bowling Green, KY (US); William C. Raper, Sparta, TN (US); Barry Lee Atkins, Goodlettsville, TN (US); Roger Dennis Cornett, Bowling Green, KY (US)

Correspondence Address: JOHN F. SALAZAR;MIDDLETON & REUTLINGER, 2500 BROWN & WILLIAMSON TOWER, LOUISVILLE, KY, 40202, US

(21) Appl. No.: 11/155,753

(22) Filed: Jun. 17, 2005

(51) Int. Cl. G08B 3/00

(52) U.S. Cl. 340/392.1

(57) ABSTRACT

A door chime system includes a microcontroller having a processor and a data memory for storing digital sound files. The microcontroller includes an input and an output representative of digital sound files; a door chime actuator having an output responsive to the depression of the doorbell electrically connected to the input of said microcontroller and an amplifier stage for converting a one of said digital sound files into sound. The output from the microcontroller representative of a digital sound file is supplied to the input of the amplifier stage responsive to the door chime output.

### BACKGROUND OF THE INVENTION

1. Field of the Invention

The present invention relates generally to door chime systems and more specifically to a door chime system capable of broadcasting sound derived from a digital sound file stored in a data memory responsive to a plurality of user inputs.

2. Description of the Related Art

Door chime systems utilizing a pushbutton to initiate the ringing of a chime or reproduction of a sound are well known. Many prior art systems employ a pushbutton or similar actuation device mounted proximate a door to activate an electrical circuit that converts electrical energy into mechanical energy to ring a chime or buzzer, or series thereof thereby producing an audible signal that someone is at the door.

Furthermore, some systems have employed a speaker or speakers rather than electromechanically acuated chimes or other sound producing instruments to broadcast a pre-recorded tone or series of tones, often responsive to a simple analog electrical signal produced by suitable circuitry upon the actuation of the doorbell pushbutton. Some of these systems offer the advantage of permitting a user to select from a plurality of tones or tunes to be used as a door chime, thereby permitting a certain level of customization of chime sounds, as predetermined by the device manufacturers.

Other prior art door chime systems employ circuitry that permits the system to play a first tune responsive to a first doorbell pushbutton, and a second tune responsive to a second doorbell pushbutton in order to enable an occupant to distinguish whether a caller is at one of two doors. Furthermore, some sophisticated doorbell systems are available that enable a user to pre-select a digitally encoded tune, or portions thereof, from a list of a plurality of stored tunes for use as a chime. However, no prior art systems employ an MP3 sound generator used in conjunction with a doorbell system wherein a user may select and download a desired tune, or a plurality thereof, and select a portion thereof to be played back upon actuation of the doorbell.

One disadvantage with the aforementioned prior art systems is that the chime sound is customizable based only upon the chime tunes or sounds provided by the manufacturer. Accordingly, these systems can not be customized by the use of user-recorded sounds. Additionally, the prior art chime systems are relatively complicated to install and configure and as such, are often costly to place in service. Finally, many prior art chime systems are unable to store a plurality of user-supplied sound data for future selection and playback.

### SUMMARY OF THE INVENTION

The disadvantages of the prior art are overcome by the door chime system of the present invention which incorporates an electronic door chime system, a means for storing a plurality of digital sound files therein, and a user interface that permits the selection of a specified digital sound file, or a portion thereof, to be broadcast responsive to the actuation of a door bell or other chime actuation means.

The present invention permits a user to download a plurality of digital sound files, for example files saved utilizing the commonplace MP3 format, into an integral data memory and select a specified file to be broadcast when the door chime is actuated. Furthermore, the system disclosed herein will permit an additional level of customization by allowing a user to select a plurality of different tunes to be broadcast upon actuation of a plurality of different door chime pushbuttons or switches, thereby permitting a user to know which pushbutton has been depressed by the customized ring sound being broadcast. This feature of the invention is particularly useful where the system is installed at a site having multiple locations for ingress and egress, for example a business or a large residential dwelling.

Other objects, features, and advantages of the present invention will become apparent from the detailed description of the preferred embodiments, taken in conjunction with the drawing Figures.

### BRIEF DESCRIPTION OF THE DRAWING FIGURES

FIG. 1 is a block diagram of a door chime system in accordance with one embodiment of the present invention.

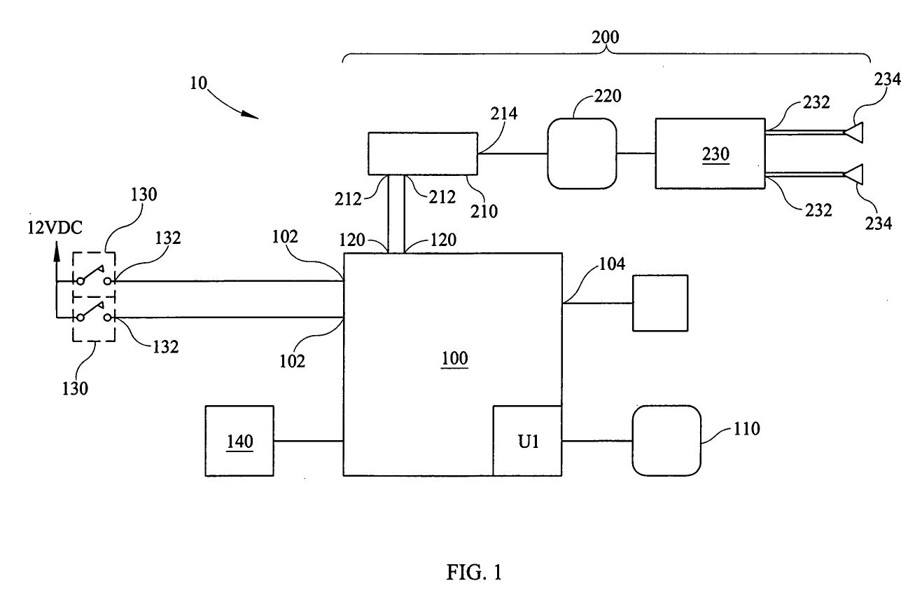

FIG. 2 is a block diagram of a door chime system in accordance with one embodiment of the present invention.

FIG. 3 is circuit diagram of a door chime system in accordance with one embodiment of the present invention.

FIG. 4 is a circuit diagram in accordance with one embodiment of the present invention.

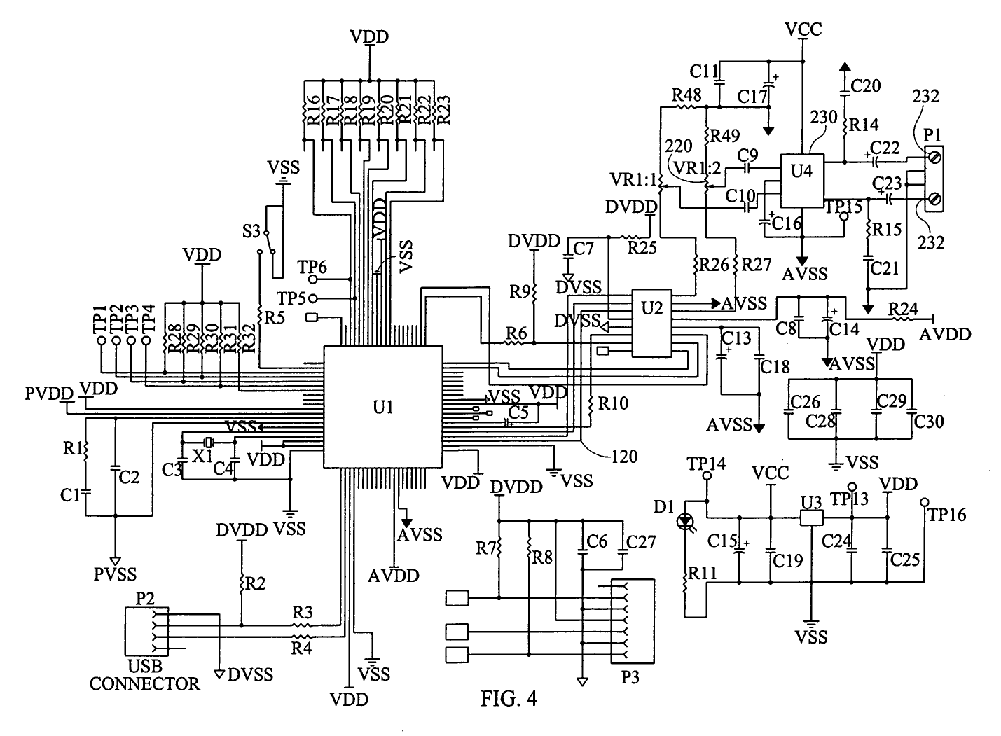

### DETAILED DESCRIPTION OF THE PREFERRED EMBODIMENT(S)

Referring now to the drawing Figures, and in accordance with one embodiment of the present invention, a door chime system 10 comprises a microcontroller 100 having a plurality of inputs 102 for receiving a plurality of door bell pushbutton 130 outputs 132. While the term “pushbutton” will be used throughout this specification to denote a device capable of initiating door chime actuation, one of ordinary skill in the art will understand that the pushbutton may be replaced with a wide variety of equivalent switches or actuators responsive to a positive act from a visitor, or alternatively, responsive to the presence of a visitor at a predetermined location whereby a sensor detects the visitor's presence and actuates the door chime system 10.

The microcontroller 100 further includes an associated data memory 110 and digital output 120 (or a plurality thereof) for supplying digital sound files to a sound reproduction system, as discussed further herein below. The data memory 110 may be integral to microcontroller 100 or may be incorporated as a separate memory card, for example a flash memory card such as one of many known in the art multi-media cards (MMC's).

The microcontroller 100 also comprises a communications port 104, for example a Universal Serial Bus (USB) port and associated connector, thereby permitting communications with a plurality of peripheral devices for downloading MP3 files or other digital sound files incorporating alternative digital formats for eventual playback. The microcontroller 100 of the present invention may further comprise one of many commercially available sound microprocessors U1, for example an AT89C51 SDN1-80 processor as manufactured and sold by Atmel Inc. which is capable of providing an output signal representative of stored MP3 file. One of ordinary skill in the art will recognize that a wide variety of microcontrollers incorporating MP3 decoders may be employed with the present invention, even including microcontrollers that incorporate MP3 decoders, D/A converters, and LCD display drivers in an integrated package. Such chipsets are available from, for example TeleChips Inc., of Seoul, South Korea.

A user interface 140 is operably connected to the microcontroller 100 to permit various features of the system 10 to be configured, as will be discussed in greater detail below. In one embodiment of the present invention the user interface 140 comprises an LCD display screen and a plurality of pushbuttons for selecting viewable menu items suitably programmed to appear on the LCD screen. A wide variety of user interface 140 devices may be employed with the system of the present invention, including but not limited to: personal computers, gaming system controllers, personal data assistants (PDA's), MP3 players, and cellular telephones.

In one embodiment of the present invention, a user may connect a pre-existing user interface with the system of the present invention, wherein the user-interface may be suitably programmed to communicate with the microcontroller 100 of the present invention via a conventional USB bus or the like. Additionally, the present invention may include a wireless communication card or device to enable communication with a remote user interface 140 via known wireless communications protocols, for example Bluetooth®. The user interface 140 enables a user to select from a plurality of chime tunes stored in data memory 110 to be played responsive to a doorbell pushbutton 130.

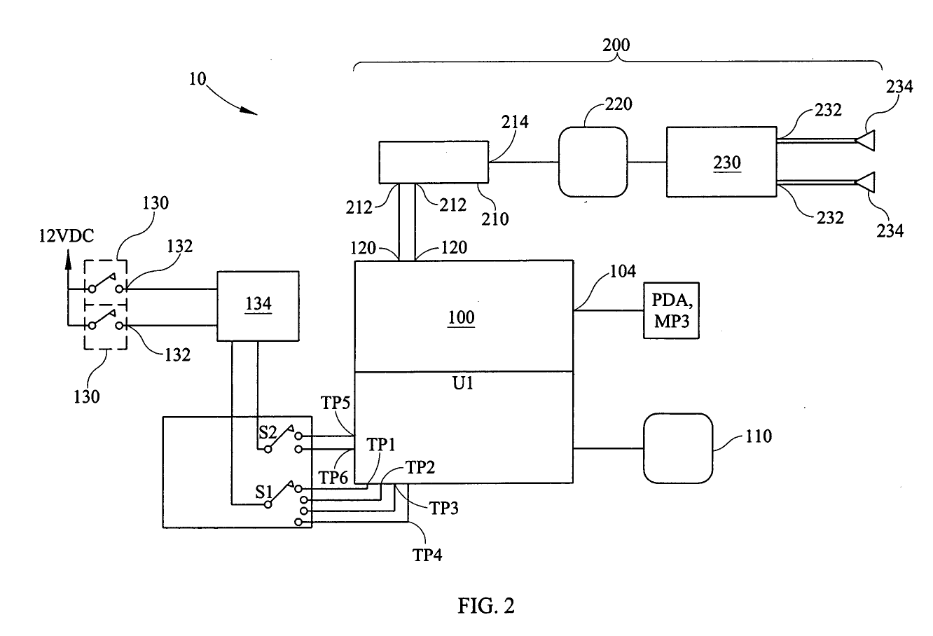

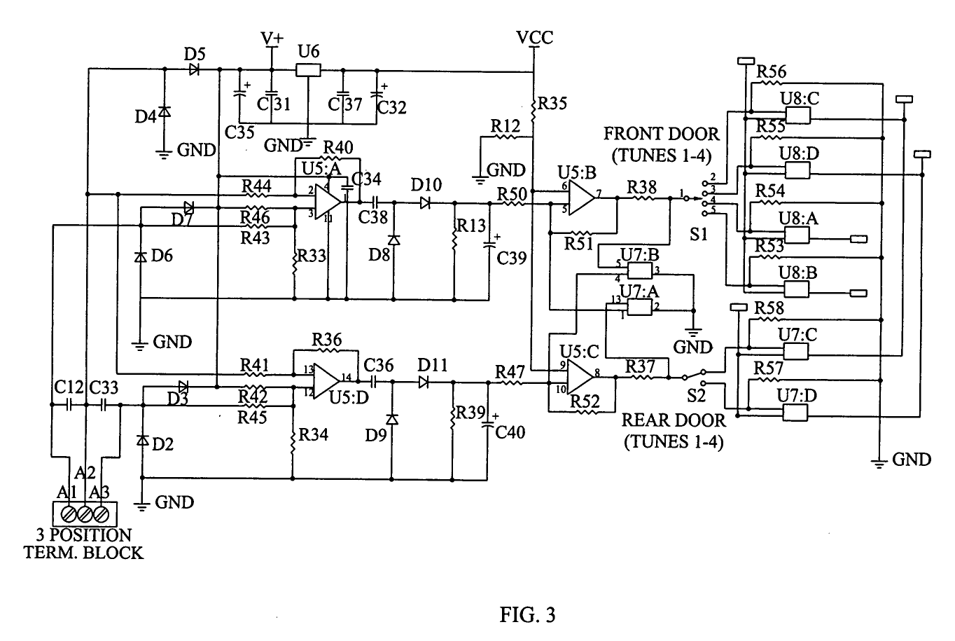

In one embodiment of the invention as seen in FIG. 2, a switch matrix 150 may be employed in place of the user interface 140 to facilitate the selection of door chime tunes to be played back and to obviate the necessity of a more costly and complex user interface 140. In this embodiment of the invention, a pushbutton 132, or a plurality thereof, is electrically connected via a pushbutton 130 detector circuit 134 through said switch matrix 150 such that a specific input selected from a plurality thereof is provided to the microcontroller responsive to the actuation of pushbutton 132. As best seen in FIGS. 2 and 3, the switch matrix 150 may comprise a plurality of simple selector switches S1 and S2, each responsive to a specific door chime pushbutton 130, that permit a user to select from among a plurality of stored chime tunes for playback.

As shown in FIG. 3, S1 permits a user to select from among 4 different chime tunes by activating outputs TP1 through TP4 depending upon the position of switch S1. Similarly, switch S2 permits a user to select from 2 different chime tunes by activating outputs TP5 or TP6 depending upon the position of switch S2. Outputs TP1-TP6 are electrically connected to 6 corresponding inputs 102 of microcontroller 100, thereby providing a signal to the microcontroller to initiate the playback of a specific tune.

The use of a simple switch matrix 150 in place of user interface 140 provides for a system 10 that is very economical to manufacture, since a more costly operator interface 140 need not be supplied. Switch matrix 150 may comprise a plurality of switches, shown as S1 and S2 in FIG. 2., having a plurality of discrete switch positions, thereby enabling a user to select from among a plurality of chime tunes. In one embodiment of the invention, the switch matrix includes 32 discrete inputs to microcontroller 100. In another embodiment of the present invention, setting a discrete input, or a combination of inputs TP1-TP6 enables a list of ring tunes to be displayed via the PDA or MP3 player for selection by a user.

Furthermore, detector circuit 134 may be one of many known-in-the-art circuit designs that provides an electrical signal output of predetermined magnitude and duration responsive to the depression of pushbutton 130. A detector circuit 134 may be used wherein a momentary depression of a pushbutton 130 provides an insufficient electrical signal to activate the MP3 player circuitry of the present invention.

The microcontroller 100 outputs 120 are electrically connected to an amplifier stage 200 comprising a digital to analog converter 210 having a plurality of inputs 212 electrically connected to the outputs 120 of microcontroller 100. The D/A converter 210 further includes a plurality of analog outputs 214 supplied to a volume control 220, which is then electrically connected to a power amplifier 230. Power amplifier 230 includes plurality of analog speaker outputs 232 that are electrically connected to a plurality of conventional speakers 234 for playback. The D/A converter 210, volume control 220 and amplifier 230 may be integral components of amplifier stage 200, which in turn may be an integral component of microcontroller 100.

In operation, when pushbutton 130 is depressed, output 132 provides an electrical signal to input 102 of microcontroller 100 to imitate door chime playback. Where multiple pushbuttons 130 are installed, a plurality of outputs 132 are electrically connected to a plurality of microcontroller inputs 102 so that the system 10 can distinguish which doorbell pushbutton 130 has been depressed, based upon the signals provided at inputs 102. A user may select, via the operator interface 140, a tune stored in data memory 110 to be played back responsive to the depression of a specific pushbutton 130. Additionally, a user may select a portion of a tune to be played back from the data memory 110, since many songs or tunes will be too long to be broadcast in their entirety as a door chime. In the embodiment of the invention employing a switch matrix 150, the switches S1 and S2 are set to select specific chime tunes for playback responsive to the depression of two separate doorbell pushbuttons 130.

The switches S1 and S2 activate one of outputs T1 through T6, depending upon which pushbutton 130 was depressed and the position of switches S1 and S2. Outputs T1-T6 are electrically connected to a plurality of inputs of sound microprocessor U1, which may be an integral component of microcontroller 100. Sound microprocessor U1 then accesses in data memory 110 the chime tune corresponding to the input provided, then outputs a digital data stream to D/A converter 210, which thence provides analog output 214 to power amp 230, thereby broadcasting the selected chime tune over speakers 234.

In one embodiment of the present invention, sound microprocessor U1 may comprise a conventional MP3 microprocessor, for example an MP3 decoder supplied by Texas instruments that is capable of accepting a plurality of inputs for the selection of chime tunes. This embodiment of the present invention permits a user to download a plurality of tunes or portions thereof that they may have already stored as MP3 files, given the widespread availability and use of the MP3 file format and the proliferation of personal MP3 player technologies.

While the present invention has been shown and described herein in what are considered to be the preferred embodiments thereof, illustrating the results and advantages over the prior art obtained through the present invention, the invention is not limited to those specific embodiments. Thus, the forms of the invention shown and described herein are to be taken as illustrative only and other embodiments may be selected without departing from the scope of the present invention, as set forth in the claims appended hereto.

I claim:

1. A door chime system comprising:
a microcontroller having a processor and a data memory associated therewith for storing a plurality of digital sound files, said microcontroller having an input and an output representative of a one of said digital sound files;
a door chime actuator having an output responsive to the actuation thereof electrically connected to the input of said microcontroller;
an amplifier stage for converting a one of said digital sound files into sound having an input electrically connected to the output of said microcontroller; and
wherein the output from said microcontroller representative of a one of said digital sound files is supplied to the input of said amplifier stage responsive to said door chime output.

2. A door chime system as claimed in claim 1 further comprising;
a communications port in electrical communications with said microprocessor to permit downloading of digital sound files to the data memory from a remote storage device.

3. A door chime system as claimed in claim 1 further comprising;
a second input to said microcontroller; and
a second door chime actuator having an output responsive to the actuation thereof electrically connected to the second input of said microcontroller; and
wherein the output from said microcontroller representative of a one of said digital sound files is supplied to the input of said amplifier stage responsive to an actuation of said second door chime activator.

4. A door chime system as claimed in claim 3 wherein the digital sound file supplied to said amplifier stage is selectable by a user.

5. A door chime system as claimed in claim 3 wherein a first digital sound file is selected when said door chime actuator is actuated and a second digital sound file is selected when said second door chime actuator is actuated.

6. A door chime system as claimed in claim 1 wherein said plurality of digital sound files comprise MP3 files.

7. A door chime system comprising:
a microcontroller having a processor and a data memory associated therewith for storing a plurality of digital sound files, said microcontroller having a plurality of inputs and at least one output representative of at least one digital sound files;
a plurality of doorbell buttons each having an output responsive to the actuation of said button electrically connected to an input of said microcontroller;
an amplifier stage for converting a one of said digital sound files into audible sound having an input for accepting the at least one output of said microcontroller; and
wherein the output from said microcontroller representative of a one of said digital sound files is supplied to the input of said amplifier stage responsive to an actuation of a doorbell button.

8. A door chime system as claimed in claim 7 wherein a distinct digital sound file is selected responsive to the actuation of each of said plurality of doorbell buttons.

9. A door chime system as claimed in claim 7 further comprising an operator interface for assigning a digital sound file to be supplied to the input of said amplifier stage for each of said plurality of doorbell buttons.

10. A door chime system as claimed in claim 9 wherein a distinct digital sound file is selected responsive to the actuation of each of said doorbell buttons.

11. A door chime system as claimed in claim 9 wherein said operator interface comprises a switch matrix operatively connected to said microcontroller.

12. A door chime system as claimed in claim 9 wherein said operator interface comprises a keypad and display operatively connected to said microcontroller.

13. A door chime system as claimed in claim 7 further comprising:
a communications port operatively connected to said microcontroller for downloading digital sound files to the data memory thereof from a remote storage device.

14. A door chime system as claimed in claim 13 wherein said communications port is a universal serial bus.

15. A door chime system as claimed in claim 7 wherein said amplifier stage further comprises:
a digital to analog converter for converting the output representative of digital sound files to an analog output signal; and
an amplifier having an input electrically connected to the analog output signal and an output electrically connected to at least one speaker.

16. A door chime system as claimed in claim 15 further comprising a volume control to vary the amplitude of the output of said amplifier.
